(19) United States
(12) Patent Application Publication
(10) Pub. No.: US 2008/0208760 A1
(43) Pub. Date: Aug. 28, 2008

(54) Method and system for verifying an electronic transaction

(75) Inventor: Thomas H. Keithley, Monkton, MD (US)

Correspondence Address: THE WEBB LAW FIRM, P.C., 700 KOPPERS BUILDING, 436 SEVENTH AVENUE, PITTSBURGH, PA, 15219, US

(73) Assignee: 14 Commerce Inc., Timonium, MD (US)

(21) Appl. No.: 11/710,784

(22) Filed: Feb. 26, 2007

(51) Int. Cl. H04L 9/00

(52) U.S. Cl. 705/75

(57) ABSTRACT

A method for verification of an electronic transaction between a consumer and a merchant, a credit issuers or any combination thereof. This method includes the steps of: obtaining a network data set including a plurality of data fields reflecting network data; obtaining a transaction data set including a plurality of data fields reflecting transaction data, consumer data, merchant data, credit issuer data or any combination thereof, directed to the electronic transaction; analyzing at least one field of the network data set and at least one field of the transaction data set; and based upon the results of the analysis, initiating an action directed to the transaction. An apparatus and system are also disclosed.

### BACKGROUND OF THE INVENTION

1. Field of the Invention

The present invention is related generally to transaction systems and similar electronic relationships between entities, such as consumers, merchants, credit issuers and other entities and, in particular, to a method and system for verifying an electronic transaction between a consumer, a merchant and/or a credit issuer, such as an online purchase transaction between a consumer and a merchant, or a credit transaction between a consumer or merchant and a credit issuer.

2. Description of Related Art

In order to enable convenient purchases of goods and services by consumers, the financial service industry has developed many alternative payment methods that allow a consumer to engage in a transaction and receive goods and services on credit. For example, such alternative payment methods may include checks, ATM or debit cards, credit cards, charge cards, etc. Prior to the birth of virtual commerce, as discussed below, such payment options provided adequate convenience and transactional security to consumers and merchants in the marketplace. Virtual commerce and the growth of the Internet as a medium for commerce have placed pressure on the payment options discussed above on the convenience, transactional security and profitability by the credit issuer. Currently, available payment options include significant shortcomings when applied to remote purchasers, such as purchases where the buyer and the seller (that is, the merchant) are not physically proximate during the transaction. Specific examples of remote purchases are mail order, telephone order, the Internet and wireless purchases.

As global commerce increases, security in transactions is more and more difficult to obtain. Many transactions are consummated by fraudsters, identification thieves and others that have somehow obtained the appropriate identification information regarding a consumer. For example, credit cards may be convenient to the consumer, but are subject to fraudulent use via theft of the account number, expiration date and address of the consumer. This, in turn, places the credit issuer at risk of offering credit to an uncreditworthy consumer, being the subject of consumer fraud or providing authorization to a merchant to provide services or ship goods to a fraudulent source.

Current available payment options include significant shortcomings when applied to remote purchasers, such as purchases where the buyer and the seller (that is, the merchant) are not physically proximate during the transaction. Further, regardless of the proximity of the consumer and the merchant, merchants and credit issuers alike continue to battle the problem of fraudulent purchases. Each new payment option and every new sales channel (in-store, telephone, mail and Internet) have, in turn, spawned innovation on the part of consumers willing to perpetrate fraud in order to obtain goods and services without paying for them.

In recent years, the birth of the Internet commerce industry and the continued growth in mail order and telephone order commerce have pushed the credit card to the forefront of these battles. Typically, merchants are forced to rely on credit cards because it is currently their only option in the remote purchase environment. However, regardless of the type of credit offered, low transactional security is offered to both merchants and consumers. This leads to significant cost for the consumers and the merchants, such as the consumer cost including the impairment of their credit record, the inconvenience of changing all of their credit card accounts and the financial cost in resolving the situation. Merchant costs may include the mitigation of fraud losses, including the cost in incremental labor, hardware and software to implement additional security checks in their sales/order entry software, higher transaction processing expense in the form of discount rates for credit cards and NSF fees for checks and higher fraud charge-offs for undetected fraudulent purchases.

An ongoing concern with any e-commerce transaction is the prevalence of malware, viruses, keyloggers, etc. Currently, electronic communications are routed to specific servers having an Internet Protocol (IP) address, which would have one or more ports associated therewith. Each port thus has a specific IP address which can be used to positively identify and communicate with the user. There is malware available that can poke into a user's personal computer to obtain private data by using the specific IP address. Since the addressing system is controlled by certain entities, each user (or port) has a unique address by design, and this address is in a standard format. In general, a user will register, identify themselves, register their name, etc., such that a fraudster can search an IP address and identify whomever owns the circuit to provide access to the Internet to the user.

In the lending perspective, the lender or bank is capable of scanning an applicant's or consumer's IP address, and comparing the IP address data (e.g., location of server) with the consumer information and location. For example, the system may already understand where the consumer lives, and can then determine whether this generally matches the location of the IP address. Therefore, there is the ability to conduct fraud checking by checking the IP address information. If there is no match, the system may decline the transaction, ask for additional information, initiate a call, etc. This tracking method is often referred to as geo-location, and there are current IP address databases and system that can be used to accomplish this.

Presently, there is available software that locates misconfigured IP addresses that are capable of or not configured to protect against exploitation, often referred to as “ghosting”. This software continues pinging IP address, connects to the address and instructs the address to send a message back. The software parses the header and indicates whether the IP address is exploitable, which would be indicated if the return header information identifies the misconfigured IP address as the source of the message. Accordingly, the system would understand that the address could be ghosted, and not indicate that the message has been forwarded from another source. There are online communities where people share and trade such exploitable IP addresses.

Still further, there exist many malware methods and software products that are able to exploit computers that are continually connected to the Internet, such as through an unprotected broadband or DSL connection, etc. Fraudsters can introduce malware through such a connection, which is invasive, but will not adversely affect the operation of the user's computer. Therefore, the user would not even be aware that the malware is present. This malware may read e-mail addresses, obtain private information, act as a keylogger (obtain information typed into input areas), etc. In addition, there is malware and viruses available that can receive messages that instruct the user's computer to spam e-mail to all of the user's contacts. Therefore, the perpetrators can send spam through an innocent user's computer. This allows for the leveraging of one infected personal computer to multiple computers in the communication range. This virus may also initiate sales transactions on a website through the victim's computer using the victim's or even another's information. In this manner, the virus can ghost transactions at the victim's computer.

Therefore, there are numerous methods and programs that are currently available to a fraudster for initiating and consummating fraudulent or sham transaction. In particular, and in the rapidly expanding area of electronic commerce, fraudulent electronic transactions are becoming commonplace and burdensome on the consumer, merchant and credit industry. Accordingly, there is considerable room in the art for additional security techniques to prevent the activities of these fraudsters.

### SUMMARY OF THE INVENTION

It is, therefore, an object of the present invention to provide a method and system for verification of an electronic transaction between a consumer and a merchant, a credit issuer, etc. It is another object of the present invention to provide a method and system for verification of an electronic transaction between a consumer and a merchant, a credit issuer, etc that ensures transactional security between entities. It is yet another object of the present invention to provide a method and system for verification of an electronic transaction between a consumer and a merchant, a credit issuer, etc that counteracts the ability of fraudsters to initiate and consummate fraudulent electronic transactions. It is a still further object of the present invention to provide a method and system for verification of an electronic transaction between a consumer and a merchant, a credit issuer, etc that prevents “ghosting” and other such online, transactional, fraudulent activities.

Accordingly, the present invention is directed to a method for verification of an electronic transaction between a consumer and a merchant, a credit issuer or any combination thereof. This method includes the steps of: obtaining a network data set including a plurality of data fields reflecting network data; obtaining a transaction data set including a plurality of data fields reflecting transaction data, consumer data, merchant data, credit issuer data or any combination thereof, directed to the electronic transaction; analyzing at least one field of the network data set and at least one field of the transaction data set; and based upon the results of the analysis, initiating an action directed to the transaction.

In another aspect, the present invention is directed to a method for verifying an electronic transaction between a consumer and a merchant, a credit issuer or any combination thereof. In this aspect, the method includes the steps of: providing a network data set including a plurality of data fields reflecting misconfigured Internet Protocol (IP) address data; providing a transaction data set including a plurality of data fields reflecting the network address utilized in the online transaction; analyzing the misconfigured network address data and the network address utilized in the electronic transaction; determining whether the network address utilized in the electronic transaction is a misconfigured network address; and based upon the results of the determination, initiating an action directed to the transaction.

The present invention is further directed to a method for verifying an electronic transaction between a consumer and a merchant, a credit issuer or any combination thereof. This method includes the steps of: providing a network data set including a plurality of data fields reflecting computer configuration data; providing a transaction data set including a plurality of data fields reflecting consumer computer configuration data for the computer used in the electronic transaction; analyzing the computer configuration data and the consumer computer configuration data; determining whether the consumer computer configuration data of the computer utilized in the electronic transaction is consumer computer configuration data indicative of a possibly fraudulent transaction; and based upon the results of the determination, initiating an action directed to the transaction.

In a still further aspect, the present invention is directed to a transaction verification system for verifying an electronic transaction between a consumer and a merchant, a credit issuer or any combination thereof. The system includes a network data set including a plurality of data fields reflecting network data; and a transaction data set including a plurality of data fields reflecting transaction data, consumer data, merchant data, credit issuer data or any combination thereof. A processing mechanism analyzes at least one field of the network address data set and at least one field of the transaction data set, and, based upon the results of the comparison, initiates an action directed to the transaction.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is schematic view of an electronic transaction according to the prior art;

FIG. 2 is a schematic view of one embodiment of a method and system for verifying an electronic transaction according to the present invention;

FIG. 3 is a schematic view of one embodiment of a method and system for verifying an electronic transaction according to the present invention;

FIG. 4 is a schematic view of a further embodiment of a method and system for verifying an electronic transaction according to the present invention;

FIG. 5 is a schematic view of a still further embodiment of method and system for verifying an electronic transaction according to the present invention; and

FIG. 6 is a schematic view of an apparatus and system for verifying an electronic transaction according to the present invention.

### DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention.

The present invention is directed to a method 100 and system 10 for use in verifying an electronic transaction between a consumer C and a merchant M, a credit issuer CI, etc. In particular, the method 100 and system 10 of the present invention is used to ensure that the electronic transaction is not fraudulent or otherwise initiated or consummated based upon the actions of a fraudster F. As the present invention is particularly adapted for use in connection with electronic transactions, these transactions between the consumers C, merchants M, credit issuers CI (and fraudsters F) all occur in a networked environment N. For example, the networked environment N may be online, on a network, on a local area network, on a wide area network, on a Virtual Private Network, on the Internet, etc. Accordingly, in order to facility the communications between the entities, a computing device 12 is used. As is known in the art, such a computing device 12 can be a personal computer, a networked computer, a laptop computer, a desktop computer, a palmtop computer, a handheld computer, a cellular phone, or any similar electronic device that allows for communications between parties in a networked environment N.

As discussed above, and according to the prior art, a fraudster F is capable of “ghosting” or otherwise manipulating the computing device 12 of the consumer C. See FIG. 1. In this manner, the fraudster F is capable of “fooling” the merchant M or credit issuer CI into thinking that it is the consumer C that is engaged in the electronic transaction. For example, and as discussed above, the fraudster F may have access to appropriate malware that can access the consumer C computing device 12 in order to obtain private data. Such malware may allow the fraudster F to route a transaction request through the consumer C computing device 12 and over the networked environment N.

Further, the fraudster F may identify various consumer C computing devices 12 that include misconfigured IP addresses, which are capable of being “ghosted”. Alternatively, the fraudster F may install the appropriate software (or malware) onto the computing device 12 of the consumer C in order to engage in transactions or otherwise compromise the security of the computing device 12 of the consumer C. In particular, the fraudster F may be capable of doing so when the computing device 12 of the consumer C is prone to such activities, e.g., improper security settings, always connected to the Internet, etc. Therefore, once the fraudster F has fooled the merchant M or credit issuer CI (or their respective computing devices 12 or systems), the fraudster F may engage in these fraudulent activities and transactions in order to illegally obtain goods, services, credit products, etc. In this manner, the arrangement of FIG. 1 illustrates an unsecure and fraud-prone transactional system between consumers C, merchants M and credit issuers CI.

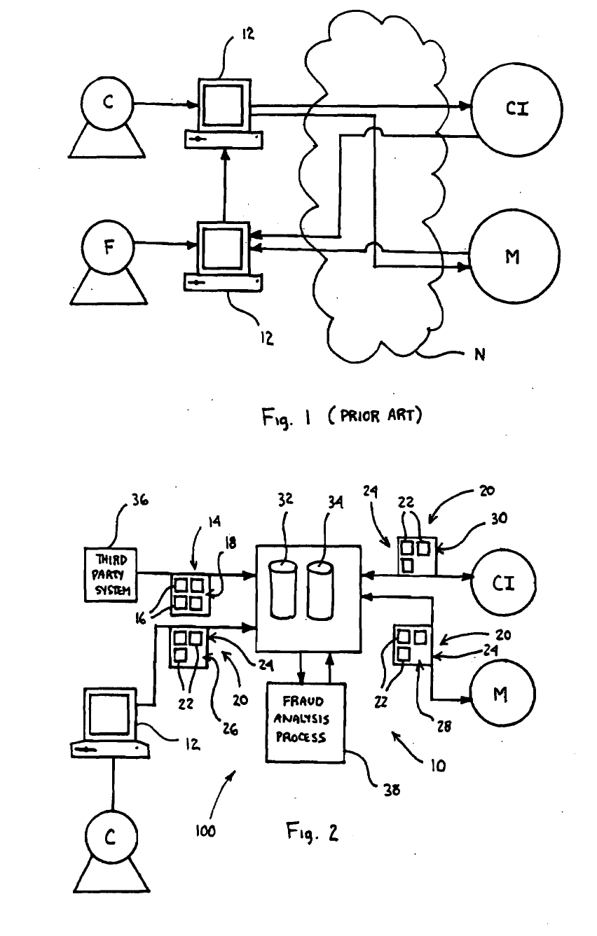

The present invention, including the method 100 and system 10 described hereinafter, serves to minimize or eliminate such fraudulent transactional occurrences. In one embodiment, and as illustrated in schematic form in FIG. 2, the present invention is directed to a method 100 (as implemented in the system 10) that verifies electronic transactions between the consumer C, the merchant M and the credit issuer CI. In particular, the method includes the steps of: obtaining a network data set 14 including multiple data fields 16, which represent network data 18; obtaining a transaction data set 20 including multiple data fields 22, which reflect transaction data 24, consumer data 26, merchant data 28, credit issuer data 30 or any combination thereof; and analyzing at least one field 16 of the network data set 14 and at least one field 22 of the transaction data set 20. Based upon the results of this analysis, the system 10 initiates some action directed toward the transaction. Further, the transaction data 24, consumer data 26, merchant data 28 and credit issuer data 30 are directed to or reflect various data points of the electronic transaction.

As seen in FIG. 2, the transaction data 24, consumer data 26, merchant data 28 and/or credit issuer data 30, once obtained by the system 10, may be stored in a transaction database 32. The transaction database 32 is structured, arranged and operable as is known in the art. Similarly, the network data 18 may be stored in a network database 34, which is also structured, arranged and operable as is known in the art. In one preferred and non-limiting embodiment, the network data set 14 is obtained from a third-party system 36. Accordingly, the system 10 (and, in particular, the network database 34) merely acts as a repository of the current data available from the third-party system 36. As there exist various third-party systems 36 that have the appropriate network data 18, which can be used in determining whether the transaction is fraudulent or not, such network data 18 may not be derived internally by the system 10. Instead, in such an embodiment, the network data 18 would be obtained from the third-party system 36.

As discussed above, the present invention analyzes the fields 16 of the network data set 14 and the fields 22 of the transaction data set 20 in order to initiate an appropriate action directed to the transaction. However, additional analysis may occur in a fraud analysis process 38, which is in communication with or otherwise part of the system 10. This fraud analysis process 38 may analyze additional or separate data fields 22 of the transaction data set 20 in order to make further and appropriate determinations regarding the transaction, the consumer C, the merchant M and/or the credit issuer CI. Therefore, for example, the system 10 may not rely solely upon the analysis directed to the network data 18 and transaction data 24, consumer data 26, merchant data 28 and credit issuer data 30, but may conduct additional analytical processes and methods in the fraud analysis process 38 in order to identify fraudulent activities or suspected fraudsters F.

In order to engage in the appropriate analysis, the network data 18 may include a variety and number of data points. For example, the network data 18 may include network address data, port data, Internet Protocol (IP) address data, network address configuration data, misconfigured network address data, IP address configuration data, misconfigured IP address data, geographical location data, network address/geographical location matching data, consumer geographical location data, merchant geographical location data, credit issuer geographical location data, consumer data, merchant data, credit issuer data, communication routing data, consumer computer data, consumer computer configuration data, consumer computer communication data, malware data, signature data, computer property data or any combination thereof.

Similarly, the transaction data 24 may include a variety of data fields 22 and data points. For example, the transaction data 24 may include product identification data, service identification data, transaction location data, identification data, geographic location data, IP address configuration data, transaction routing data, communication data, consumer's name, a consumer key, a consumer identification, an account number, an address, a city, a state, a zip code, a country, a telephone number, an e-mail address, a social security number, a date of birth, the merchant's name, an identification, a credit issuers name, credit issuer data, credit data, credit product data, credit rate data, credit terms data, credit product benefits data, a merchant name, a product identification, a service identification, a company identity, a merchant identity, consumer credit account balance, merchant history, private label entity data, affiliated private label entity, transaction data, transaction type, transaction amount or any combination thereof.

The consumer data 26 may include consumer identification data, identification data, transaction data, geographical location data, IP address configuration data, consumer location data, consumer computer data, consumer computer configuration data, consumer computer communication data, consumer network data, consumer network address data, consumer port data, consumer's name, a consumer key, a consumer identification, an account number, an address, a city, a state, a zip code, a country, a telephone number, an e-mail address, a social security number, a date of birth, the merchant's name, an identification, a credit issuer's name, credit issuer data, credit data, credit product data, credit rate data, credit terms data, credit product benefits data, a product identification, a service identification, a company identity, a merchant identity, consumer credit account balance, merchant history, private label entity data, affiliated private label entity, transaction data, transaction type, transaction amount historical interaction between the consumer and the credit issuer, historical data, merchant data, previous consumer/credit issuer transaction data, consumer creditworthiness, consumer credit quality, size of purchase, type of purchase, consumer demographic data, consumer age, consumer location, consumer income, consumer credit data, consumer purchasing behavior, consumer purchasing behavior with a specified credit issuer, credit issuer sales objectives, credit issuer goals, consumer purchasing history, consumer status, consumer lifetime value to credit issuer, credit issuer input data, consumer input data, product credit rate, product credit terms, product benefit data, product relationships, product tie-ins, consumer purchasing behavior at a specified merchant, merchant objectives, merchant goals, consumer lifetime value to merchant, merchant input data, a transaction amount, a consumer purchase demographic, a product identification, a service identification, consumer type, a company identity, a merchant identity, a third-party risk score, risk data, authentication data, verification data, consumer rating data, profitability data, credit risk data, fraud risk data, transaction risk data, denial data, processing data, a general credit risk score, a credit bureau risk score, a prior approval, prior report data, previous transaction data, a geographical risk factor, credit account data, bankcard balance data, delinquency data, credit segment data, previous transaction data, time between transactions data, previous transaction amount, previous transaction approval status, previous transaction time stamp data, a response code, active trades in database, public record data, trade line data, transaction medium, credit segment data, consumer payment type, consumer payment method, consumer payment history, consumer account history, consumer credit account balance, merchant history, private label entity data, affiliated private label entity, consumer/merchant historical data, negative consumer/credit issuer data, positive consumer/credit issuer data, or any combination thereof.

The merchant data 28 may include merchant identification data, identification data, transaction data, geographical location data, IP address configuration data, merchant location data, merchant computer data, merchant computer configuration data, merchant computer communication data, merchant network data, merchant network address data, merchant port data, merchant's name, identification, code, contact information, an account number, an address, a city, a state, a zip code, a country, a telephone number, a facsimile number, an e-mail address, location, distributor data, store data, website data, category, product offerings, service offerings, associated items, associated services, field or any combination thereof.

Still further, the credit issuer data 30 may include credit issuer identification data, identification data, transaction data, geographical location data, IP address configuration data, credit issuer location data, credit issuer computer data, credit issuer computer configuration data, credit issuer computer communication data, credit issuer network data, credit issuer network address data, credit issuer port data, credit issuer's name, historical interaction between the consumer and the credit issuer, historical data, merchant data, previous consumer/credit issuer transaction data, consumer creditworthiness, consumer credit quality, size of purchase, type of purchase, consumer demographic data, consumer age, consumer location, consumer income, consumer credit data, consumer purchasing behavior, consumer purchasing behavior with a specified credit issuer, credit issuer sales objectives, credit issuer goals, consumer purchasing history, consumer status, consumer lifetime value to credit issuer, credit issuer input data, consumer input data, product credit rate, product credit terms, product benefit data, product relationships, product tie-ins, consumer purchasing behavior at a specified merchant, merchant objectives, merchant goals, consumer lifetime value to merchant, merchant input data, a transaction amount, a consumer purchase demographic, a product identification, a service identification, consumer type, a company identity, a merchant identity, a third-party risk score, risk data, authentication data, verification data, consumer rating data, profitability data, credit risk data, fraud risk data, transaction risk data, denial data, processing data, a general credit risk score, a credit bureau risk score, a prior approval, prior report data, previous transaction data, a geographical risk factor, credit account data, bankcard balance data, delinquency data, credit segment data, previous transaction data, time between transactions data, previous transaction amount, previous transaction approval status, previous transaction time stamp data, a response code, active trades in database, public record data, trade line data, transaction medium, credit segment data, consumer payment type, consumer payment method, consumer payment history, consumer account history, consumer credit account balance, merchant history, private label entity data, affiliated private label entity, consumer/merchant historical data, negative consumer/credit issuer data, positive consumer/credit issuer data, or any combination thereof.

As discussed above, and in a preferred and non-limiting embodiment, the electronic transaction is an online transaction between a consumer C and a merchant M, the credit issuer CI, etc. In this manner and as discussed above, the online transaction may occur in the networked environment N, and is typically occurring over the Internet.

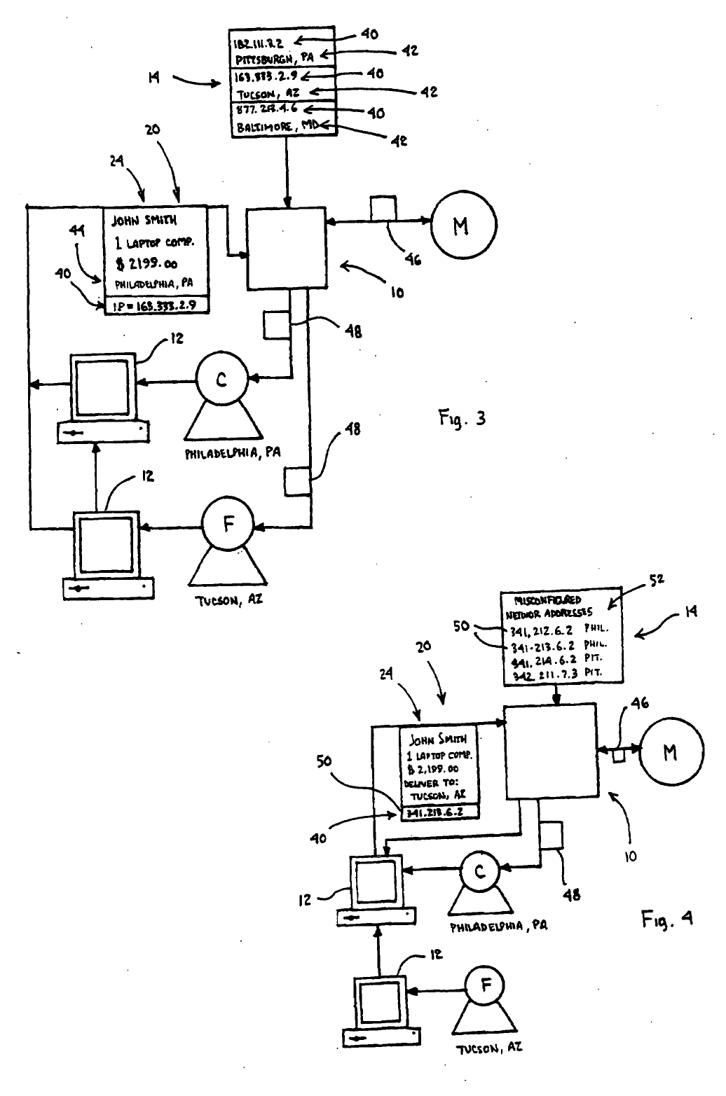

In order to obtain appropriate results and initiate the required and responsive actions during the transaction, the comparison and analysis includes parsing the data and engaging in the appropriate decision-making processes. For example, in one preferred and non-limiting embodiment, a network address 40 may be obtained from the transaction data set 20, where this network address 40 is associated with the online transaction. Next, the system 10 may identify the network address 40 and corresponding network address geographical location 42 from the network data set 14. Next, the geographical location data 44 of the consumer is obtained from the transaction data set 20. Finally, the identified consumer geographical location data 44 is compared and analyzed against the identified network address geographical location data 42. This process is illustrated in schematic form in FIG. 3.

As seen in the example of FIG. 3, the consumer C is located in Philadelphia, Pa., and the fraudster F is located in Tucson, Ariz. The system 10 of the present invention obtains the appropriate network data set 14 (e.g., from the network database 34), and also identifies that the consumer C is located in Philadelphia, Pa. from the transaction data set 20 or some other existing data set. However, when the system 10 analyzes the data, the network address 40 that is associated with the transaction data 24, as obtained from the transaction data set 20, indicates that this network address 40 is in Tucson, Ariz. (the location of the fraudster F). The system 10 obtains this knowledge by parsing the network data set 14, which, in this embodiment, includes a listing or library of network addresses 40 in the associated geographical location data 42 of the network address 40.

If, during the comparison and analysis process, the identified consumer geographical location data 44 does not substantially match the identified network address geographical location data 42, various additional actions may be taken. However, it should also be noted that the analysis may or may not stop here depending upon the level of implementation of the method 100 and system 10 of the present invention.

It is contemplated that various actions may be engaged in by the system 10 if, after the analytical and comparison process, the data is either inconsistent or indicative of possible fraud. For example, in one embodiment, transaction action data 46 may be provided to the merchant M, the credit issuer CI, etc. This transaction action data 46 may include transaction denial data, a transaction denial request, credit amount data, credit limit data, credit limit request, transaction processing data, transaction initiation data, transaction consummation data, transaction confirmation data, etc. Accordingly, the system 10 may instruct the merchant M or the credit issuer CI to deny the electronic transaction, reassess or limit the amount of credit extended to the consumer C (possible fraudster F), take additional processing, initiation or consummation steps, confirm the transaction or engage in some other communication with consumer C, etc.

In this manner, the system 10 instructs or suggests that the merchant M or credit issuer CI take appropriate action based upon the results of the comparison and analytical processes, which may provide some indication of possible fraudulent activity. Of course, if this is the only level of analysis conducted in connection with the transaction (which may not be preferable), the system 10 may simply instruct the merchant M or credit issuer CI to move forward in the transaction and provide the consumer C with the goods, services, credit products, etc.

In another embodiment, the action taken by the system 10 may include transmitting additional data request data 48 to the consumer C, which also may result in this request data 48 being transmitted to the fraudster F. The additional data request data 48 may include a request for additional data, a request for additional information, a request for verification data, suggestion data, flagging data, etc. This means that the system 10 would be in direct or indirect communication with the consumer C, and possibly the fraudster F, and require further information in order to identify the legitimacy of the consumer C.

If the fraudster F only has the ability to route transactions through the computing device 12 to consumer C, but does not have additional critical data regarding the consumer C, e.g., the consumer's social security number, the system 10 may then initiate the transmission of the transaction action data 46 to the merchant M or credit issuer CI. Of course, if the consumer C does provide the appropriate information to the satisfaction of the system 10, the system 10 may then instruct the merchant M or credit issuer CI to move forward in the transaction.

As discussed above, this initial matching of the network address geographical location data 42 and consumer geographical location data 44 may be only the first step in the analytical process. Accordingly, even if the identified consumer geographical location data 44 and the identified network address geographical location data 42 do match, further analysis of the data fields 22 and the transaction data set 20 (and/or data fields 16 in the network data set 14) occurs. Additional analysis may be warranted since this geo-location technique does not always indicate a valid consumer C or electronic transaction. In particular, the network address 40 data is only as reliable as the scheme, and the geo-location technique described above will only help if the identified network address 40 is the true source of the transaction. As discussed, there are programs, methods and other malware that allow data, e.g., transaction data 24, to be routed through another person's or consumer's computing device 12, and therefore their network address 40. In this manner, fraudsters F may indeed pass the geo-location test, make a purchase with a delivery near the victim's network address 40, and change the delivery point in a later inquiry or communication.

As discussed in connection with “ghosting” another person's computer, fraudsters F may obtain a listing or library of misconfigured network addresses 50. Such a misconfigured network address 50 will allow the fraudster F to route transactions through the consumer's computing device 12 (without the knowledge of the consumer C) and therefore pass the geo-location test, but still successfully engage in a fraudulent transaction.

Accordingly, and as illustrated in schematic form in FIG. 4, the analytical process of the present invention may also include identifying or otherwise obtaining network address configuration data 52 in the network data set 14, where this network address configuration data 52 includes misconfigured network addresses 50. Next, the system 10 will analyze the misconfigured network address 50 data against the network address 40 used in the online transaction from the transaction data set 20. In this manner, the system will determine whether the network address 40 used in the online transaction is a misconfigured network address 50.

As seen in the example of FIG. 4, the system 10 obtains a listing or library of misconfigured network addresses 50 in the form of network address configuration data 52 in the network data set 14. In addition, the system 10 obtains the transaction data set 20, which includes, as part of the transaction data 24, the network address 40 of the consumer C. Again, in this example, the consumer C is in Philadelphia, Pa. and the fraudster F is in Tucson, Ariz. However, since the network address 40 of the consumer C is a misconfigured network address 50, the fraudster F is able to “ghost” the computing device 12 of the consumer C, thereby passing the geo-location test. However, the system is capable of analyzing, comparing and matching the misconfigured network address 50 of the consumer C with the list of misconfigured network addresses 50 in the network data set 14. Based upon this information, the system 10 may engage in various actions and activities.

As discussed above, the system 10 may provide transaction action data 46 to the merchant M (or credit issuer CI) and/or may transmit additional data request data 48 to the consumer C (or fraudster F). In addition, further analysis may be performed. It is quite possible that the transaction is not fraudulent, since a fraudulent electronic transaction is not necessarily evident simply from a misconfigured network address 50. Therefore, it would not be preferable to simply instruct the merchant M to deny the transaction. Instead, either the merchant M or the system 10 may send the additional data request data 48 to the consumer C in order to obtain additional verifying information regarding the identity of the consumer and veracity of the transaction. If this burden is satisfied, the transaction would move forward. However, if inappropriate information was received, the transaction may be denied.

Still further, in another preferred and non-limiting embodiment, the system 10 may communicate with the consumer C and inform them that they are operating on a misconfigured network address 50, which is open to exploitation. Further, if an additional data request is sent and returns inadequate or improper information (as would be transmitted from the fraudster F), the system 10 may communicate with the consumer C and indicate that they are the possible subject of fraud or identity theft. Therefore, the consumer C would be able to take appropriate action on his or her side in order to correct the situation. Accordingly, the method 100 and system 10 may be not only useful in identifying possible fraud, but also in communicating with and otherwise helping the consumer C to engage in more secure online activities and transactions.

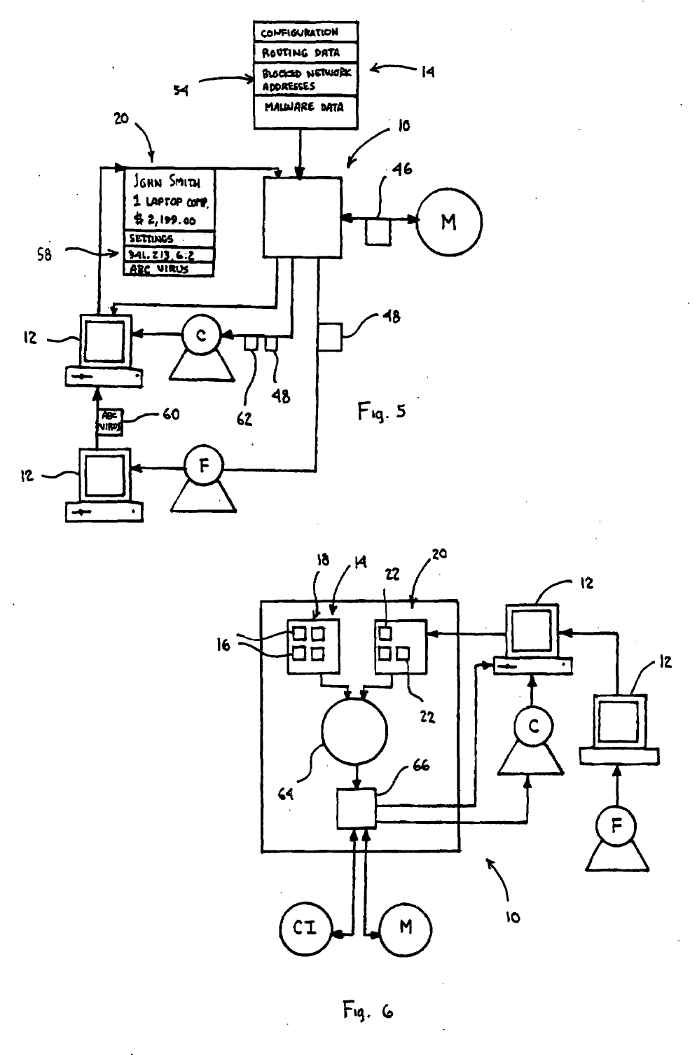

In yet another preferred and non-limiting embodiment, and as illustrated in FIG. 5, the system 10 may obtain identification data 54 that is associated with the online transaction from the transaction data set 20. This identification data 54 would include data sufficient to identify a network address 40 associated with the consumer C, a port associated with the consumer C, a computer (or computing device 12) associated with the consumer C, etc. Next, the system would identify matching identification data 54 associated with the online transaction and identification data 54 in the network data set 14. In this embodiment, the network data 18 may include communication routing data, network address 40, port data, consumer computing device 12 data, consumer computer configuration data, consumer computer communication data, computer configuration data 56, malware data, signature data, computer property data, etc.

Further, in this embodiment, the transaction data 24 in the transaction data set 20 would include consumer computer configuration data 58. This consumer computer configuration data 58 may be transmitted as part of the transaction data set 20 or already be known and identified by the system 10 and the transaction database 32. In either case, the system 10 may then analyze and identify whether the consumer computer configuration data 58 is indicative of a possibly fraudulent transaction by parsing and identifying matching network data 18, such as the computer configuration data 56. The computer configuration data 56 in the network data set 14 would include the settings, properties and other attributes of a computing device 12 that may evidence fraud.

For example, as seen in FIG. 5, the fraudster F has uploaded or otherwise transmitted a piece of malware 60 to the computing device 12 of the consumer C. This malware 60, which may be a virus, scripting tool, keylogger, or other software that compromises the security of the computing device 12 of the consumer C, makes the consumer C prone to victimization by the fraudster F. For example, this malware 60 may modify the settings of the computing device 12 of the consumer C, modify the routing data of the consumer computing device 12, change the configuration data of the consumer computing device 12 or otherwise implement or execute programs that allow the fraudster F to engage in fraudulent and other damaging activity on the computing device 12 of the consumer C.

As discussed above, if such inappropriate properties, attributes, configurations, settings or malware is discovered or matched between the network data 18 and the transaction data 24, all of the above steps may be taken during the transactional process. Again, appropriate transaction action data 46 may be sent to the merchant M, additional data request data 48 may be transmitted to the consumer C (or fraudster F) or additional analysis may occur. As discussed above, it may be that the transaction is, indeed, valid and initiated by the consumer C, regardless of the consumer computer configuration data 58. However, the presently-invented method 100 and system 10 allow the system 10 to take further actions to ensure its validity.

As discussed above in connection with the misconfigured network address 50 embodiment, the system 10 may provide or transmit some communication 62 to the consumer C regarding the situation. If the transaction is fraudulent, the consumer C may take appropriate steps. If the transaction is not fraudulent, but the consumer computer configuration data 58 is indicative of inappropriate settings, properties, attributes or malware 60 on the computing device 12 of the consumer C, such information can be provided to the consumer C for correction. Therefore, the consumer C could engage in the appropriate effort to remove the malware 60 or otherwise adjust the settings, properties and attributes of the computing device 12 to minimize the risk of exploitation.

The identification data 54 obtained as part of the network data set 14 may also include “blocked” network addresses 40 for specified persons or entities. Often, Internet Service Providers (ISP) utilize systems that tag potential spam sources and examine the routing data. The ISPs engage in these activities in order to ensure that their service is not being used to spam third parties. This process automatically tags certain network addresses 40 as “spammers” and creates a block listing. Accordingly, the system 10 may obtain a similar DNS block list from the ISP (third-party system 36) and parse it to ascertain why the source was listed. The system 10 could then correlate the reasons behind the blocking to fraud indicators, such as infected computers having a virus capable of perpetrating fraud. For example, the third-party system 36, or alternatively the system 10, may run certain diagnostics to look for the signatures of specific malware 60, and such a listing would indicate that this malware 60 could be used in connection with fraudulent activities. Therefore using the analytical engine of the system 10 or the associated fraud analysis process 38, the appropriate activities may be initiated with respect to the consumer C engaged in the electronic transaction.

Another benefit of the presently-invented method 100 and system 10 is its ability to occur substantially in real time. In addition, the transaction data set 20 and/or the network data set 14 may be provided to the system 10 as an updated, dynamic database. This will allow the system 10 to make appropriate decisions regarding the electronic transaction as it is occurring and prior to its consummation. In addition, when used in connection with a fraud analysis process 38, additional fraud checking and verification can occur in real time and while the transaction is commencing.

The method 100 and system 10 may be implemented or operable on a variety of mechanisms and computer systems, as is known in the art. For example, as illustrated in schematic form in FIG. 6, the transaction verification system 10 of the present invention may include a processing mechanism 64 configured or adapted to engage in the proper analysis to achieve the inventive method. In addition, a communication mechanism 66 may be included to communicate data and other information to the consumer C, the merchant M, the credit issuer CI, etc. Still further, this communication mechanism 66 can be used to engage in the above-described actions, including the provision of transaction action data 46, transmission of additional data request data 48, etc. It is also envisioned that the processor mechanism 64 be used to engage in and conduct the fraud analysis process 38 for additional and further verification purposes.

In this manner, the present invention provides a method 100 and system 10 for verifying electronic transactions between consumers C, merchants M and credit issuers CI. The method 100 and system 10 ensures transactional security between the entities and counteracts the ability of fraudsters F to initiate and consummate fraudulent electronic transactions. In addition, the presently-invented method 100 and system 10 allows for the verification of an electronic transaction that prevents or otherwise minimizes “ghosting” and other similar online, transactional, fraudulent activities.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method for verifying an electronic transaction between a consumer and a merchant, a credit issuer or any combination thereof, the method comprising the steps of:
obtaining a network data set including a plurality of data fields reflecting network data;
obtaining a transaction data set including a plurality of data fields reflecting transaction data, consumer data, merchant data, credit issuer data or any combination thereof, directed to the electronic transaction;
analyzing at least one field of the network data set and at least one field of the transaction data set; and
based upon the results of the analysis, initiating an action directed to the transaction.

2. The method of claim 1, wherein the network data comprises network address data, port data, Internet Protocol (IP) address data, network address configuration data, misconfigured network address data, IP address configuration data, misconfigured IP address data, geographical location data, network address/geographical location matching data, consumer geographical location data, merchant geographical location data, credit issuer geographical location data, consumer data, merchant data, credit issuer data, communication routing data, consumer computer data, consumer computer configuration data, consumer computer communication data, malware data, signature data, computer property data or any combination thereof.

3. The method of claim 1, wherein the transaction data comprises product identification data, service identification data, transaction location data, identification data, geographic location data, IP address configuration data, transaction routing data, communication data, consumer's name, a consumer key, a consumer identification, an account number, an address, a city, a state, a zip code, a country, a telephone number, an e-mail address, a social security number, a date of birth, the merchant's name, an identification, a credit issuers name, credit issuer data, credit data, credit product data, credit rate data, credit terms data, credit product benefits data, a merchant name, a product identification, a service identification, a company identity, a merchant identity, consumer credit account balance, merchant history, private label entity data, affiliated private label entity, transaction data, transaction type, transaction amount or any combination thereof.

4. The method of claim 1, wherein the consumer data comprises consumer identification data, identification data, transaction data, geographical location data, IP address configuration data, consumer location data, consumer computer data, consumer computer configuration data, consumer computer communication data, consumer network data, consumer network address data, consumer port data, consumer's name, a consumer key, a consumer identification, an account number, an address, a city, a state, a zip code, a country, a telephone number, an e-mail address, a social security number, a date of birth, the merchant's name, an identification, a credit issuers name, credit issuer data, credit data, credit product data, credit rate data, credit terms data, credit product benefits data, a product identification, a service identification, a company identity, a merchant identity, consumer credit account balance, merchant history, private label entity data, affiliated private label entity, transaction data, transaction type, transaction amount historical interaction between the consumer and the credit issuer, historical data, merchant data, previous consumer/credit issuer transaction data, consumer creditworthiness, consumer credit quality, size of purchase, type of purchase, consumer demographic data, consumer age, consumer location, consumer income, consumer credit data, consumer purchasing behavior, consumer purchasing behavior with a specified credit issuer, credit issuer sales objectives, credit issuer goals, consumer purchasing history, consumer status, consumer lifetime value to credit issuer, credit issuer input data, consumer input data, product credit rate, product credit terms, product benefit data, product relationships, product tie-ins, consumer purchasing behavior at a specified merchant, merchant objectives, merchant goals, consumer lifetime value to merchant, merchant input data, a transaction amount, a consumer purchase demographic, a product identification, a service identification, consumer type, a company identity, a merchant identity, a third-party risk score, risk data, authentication data, verification data, consumer rating data, profitability data, credit risk data, fraud risk data, transaction risk data, denial data, processing data, a general credit risk score, a credit bureau risk score, a prior approval, prior report data, previous transaction data, a geographical risk factor, credit account data, bankcard balance data, delinquency data, credit segment data, previous transaction data, time between transactions data, previous transaction amount, previous transaction approval status, previous transaction time stamp data, a response code, active trades in database, public record data, trade line data, transaction medium, credit segment data, consumer payment type, consumer payment method, consumer payment history, consumer account history, consumer credit account balance, merchant history, private label entity data, affiliated private label entity, consumer/merchant historical data, negative consumer/credit issuer data, positive consumer/credit issuer data, or any combination thereof.

5. The method of claim 1, wherein the merchant data comprises merchant identification data, identification data, transaction data, geographical location data, IP address configuration data, merchant location data, merchant computer data, merchant computer configuration data, merchant computer communication data, merchant network data, merchant network address data, merchant port data, merchant's name, identification, code, contact information, an account number, an address, a city, a state, a zip code, a country, a telephone number, a facsimile number, an e-mail address, location, distributor data, store data, website data, category, product offerings, service offerings, associated items, associated services, field or any combination thereof.

6. The method of claim 1, wherein the credit issuer data comprises credit issuer identification data, identification data, transaction data, geographical location data, IP address configuration data, credit issuer location data, credit issuer computer data, credit issuer computer configuration data, credit issuer computer communication data, credit issuer network data, credit issuer network address data, credit issuer port data, credit issuer's name, historical interaction between the consumer and the credit issuer, historical data, merchant data, previous consumer/credit issuer transaction data, consumer creditworthiness, consumer credit quality, size of purchase, type of purchase, consumer demographic data, consumer age, consumer location, consumer income, consumer credit data, consumer purchasing behavior, consumer purchasing behavior with a specified credit issuer, credit issuer sales objectives, credit issuer goals, consumer purchasing history, consumer status, consumer lifetime value to credit issuer, credit issuer input data, consumer input data, product credit rate, product credit terms, product benefit data, product relationships, product tie-ins, consumer purchasing behavior at a specified merchant, merchant objectives, merchant goals, consumer lifetime value to merchant, merchant input data, a transaction amount, a consumer purchase demographic, a product identification, a service identification, consumer type, a company identity, a merchant identity, a third-party risk score, risk data, authentication data, verification data, consumer rating data, profitability data, credit risk data, fraud risk data, transaction risk data, denial data, processing data, a general credit risk score, a credit bureau risk score, a prior approval, prior report data, previous transaction data, a geographical risk factor, credit account data, bankcard balance data, delinquency data, credit segment data, previous transaction data, time between transactions data, previous transaction amount, previous transaction approval status, previous transaction time stamp data, a response code, active trades in database, public record data, trade line data, transaction medium, credit segment data, consumer payment type, consumer payment method, consumer payment history, consumer account history, consumer credit account balance, merchant history, private label entity data, affiliated private label entity, consumer/merchant historical data, negative consumer/credit issuer data, positive consumer/credit issuer data, or any combination thereof.

7. The method of claim 1, wherein the electronic transaction is an online transaction between the consumer and the merchant, the credit issuer or any combination thereof.

8. The method of claim 1, wherein the comparing step includes:
obtaining a network address from the transaction data set associated with the online transaction;
identifying the network address and corresponding network address geographical location data in the network data set;
identifying consumer geographical location data associated with the consumer from the transaction data set; and
analyzing the identified consumer geographical location data and the identified network address geographical data.

9. The method of claim 8, further comprising the steps of:
comparing the identified consumer geographical location data and the identified network address geographical data; and
if the identified consumer geographical location data does not substantially match the identified network address geographical data:
(i) providing transaction action data to the merchant, the credit issuer or any combination thereof,
(ii) transmitting additional data request data to the consumer, the merchant, the credit issuer or any combination thereof,
(iii) further analyzing at least a portion of the transaction data set, or any combination thereof.

10. The method of claim 9, wherein the transaction action data includes transaction denial data, a transaction denial request, credit amount data, credit limit data, a credit limit request, transaction processing data, transaction initiation data, transaction consummation data, transaction confirmation data or any combination thereof.

11. The method of claim 9, wherein the additional data request data includes a request for additional data, a request for additional information, a request for verification data, suggestion data, flag data or any combination thereof.

12. The method of claim 8, further comprising the steps of:
identifying network address configuration data in the network data set, the network address configuration data comprising misconfigured network address data;
analyzing the misconfigured network address data and the network address utilized in the online transaction in the transaction data set; and
determining whether the network address utilized in the online transaction is a misconfigured network address.

13. The method of claim 12, wherein if the network address utilized in the online transaction is a misconfigured network address:
providing transaction action data to the merchant, the credit issuer or any combination thereof;
transmitting additional data request data to the consumer, the merchant, the credit issuer or any combination thereof;
further analyzing at least a portion of the transaction data set;
or any combination thereof.

14. The method of claim 13, wherein the transaction action data includes transaction denial data, a transaction denial request, credit amount data, credit limit data, a credit limit request, transaction processing data, transaction initiation data, transaction consummation data, transaction confirmation data or any combination thereof.

15. The method of claim 13, wherein the additional data request data includes a request for additional data, a request for additional information, a request for verification data, suggestion data, flag data or any combination thereof.

16. The method of claim 1, wherein the transaction is a purchase of goods, a purchase of services, an online transaction, an online commerce transaction, an credit transaction, a credit request, an initial credit request or any combination thereof.

17. The method of claim 1, wherein the action directed to the transaction comprises:
providing transaction action data to the merchant, the credit issuer or any combination thereof;
transmitting additional data request data to the consumer, the merchant, the credit issuer or any combination thereof;
further analyzing at least a portion of the transaction data set;
or any combination thereof.

18. The method of claim 17, wherein the transaction action data includes transaction denial data, a transaction denial request, credit amount data, credit limit data, a credit limit request, transaction processing data, transaction initiation data, transaction consummation data, transaction confirmation data or any combination thereof.

19. The method of claim 17, wherein the additional data request data includes a request for additional data, a request for additional information, a request for verification data, suggestion data, flag data or any combination thereof.

20. The method of claim of claim 1, further comprising the steps of:
obtaining identification data associated with the online transaction from the transaction data set, the identification data comprising data sufficient to identify a network address associated with the consumer, a port associated with the consumer, a computer associated with the consumer or any combination thereof; and
identifying matching identification data associated with the online transaction and identification data in the network data set.

21. The method of claim 20, wherein the network data comprises communication routing data, network address, port data, consumer computer data, consumer computer configuration data, consumer computer communication data, computer configuration data, malware data, signature data, computer property data or any combination thereof, and wherein the transaction data comprises consumer computer configuration data, and wherein the analysis step comprises identifying whether the consumer computer configuration data is indicative of a possibly fraudulent transaction by parsing and identifying matching network data.

22. The method of claim 21, further comprises the step of initiating a communication to the consumer.

23. The method of claim 22, wherein the communication comprises a notification to the consumer of the consumer computer configuration data.

24. The method of claim 1, wherein the analysis step is performed substantially in real time.

25. The method of claim 1, wherein the transaction data set, the network data set or any combination thereof, is provide as an updated, dynamic database.

26. The method of claim 1, wherein the action comprises the step of additionally analyzing at least a portion of the transaction data set in a fraud analysis process.

27. The method of claim 1, wherein the network data set is in the form of a database built based at least in part upon a third-party database.

28. A method for verifying an electronic transaction between a consumer and a merchant, a credit issuer or any combination thereof, the method comprising the steps of:
providing a network data set including a plurality of data fields reflecting misconfigured Internet Protocol (IP) address data;
providing a transaction data set including a plurality of data fields reflecting the network address utilized in the online transaction;
analyzing the misconfigured network address data and the network address utilized in the electronic transaction;
determining whether the network address utilized in the electronic transaction is a misconfigured network address; and
based upon the results of the determination, initiating an action directed to the transaction.

29. A method for verifying an electronic transaction between a consumer and a merchant, a credit issuer or any combination thereof, the method comprising the steps of:
providing a network data set including a plurality of data fields reflecting computer configuration data;
providing a transaction data set including a plurality of data fields reflecting consumer computer configuration data for the computer used in the electronic transaction;
analyzing the computer configuration data and the consumer computer configuration data;
determining whether the consumer computer configuration data of the computer utilized in the electronic transaction is consumer computer configuration data indicative of a possibly fraudulent transaction; and
based upon the results of the determination, initiating an action directed to the transaction.

30. A transaction verification system for verifying an electronic transaction between a consumer and a merchant, a credit issuer or any combination thereof, the system comprising: a network data set including a plurality of data fields reflecting network data;
a transaction data set including a plurality of data fields reflecting transaction data, consumer data, merchant data, credit issuer data or any combination thereof; and
a processing mechanism configured to:
analyze at least one field of the network address data set and at least one field of the transaction data set; and
based upon the results of the comparison, initiate an action directed to the transaction.

31. The method of claim 30, further comprising a communication mechanism configured to transmit or communicate data to the consumer, the merchant, the credit issuer or any combination thereof.

32. The method of claim 31, wherein the communication mechanism is further configured to:
provide transaction action data to the merchant, the credit issuer or any combination thereof;
transmit additional data request data to the consumer, the merchant, the credit issuer or any combination thereof;
or any combination thereof.

33. The method of claim 30, wherein the processor mechanism is further configured to analyze at least a portion of the transaction data in a fraud analysis process.
